(19) United States
(12) Patent Application Publication
(10) Pub. No.: US 2006/0181875 A1
(43) Pub. Date: Aug. 17, 2006

(54) Highly reflective lighting fixture visor

(75) Inventors: Myron K. Gordin, Oskaloosa, IA (US); Timothy J. Boyle, Oskaloosa, IA (US)

Correspondence Address: MCKEE, VOORHEES & SEASE, P.L.C., 801 GRAND AVENUE, SUITE 3200, DES MOINES, IA, 50309-2721, US

(73) Assignee: MUSCO CORPORATION, Oskaloosa, IA (US)

(21) Appl. No.: 11/334,007

(22) Filed: Jan. 18, 2006

Related U.S. Application Data
(60) Provisional application No. 60/644,687, filed on Jan. 18, 2005.
(60) Provisional application No. 60/644,639, filed on Jan. 18, 2005.
(60) Provisional application No. 60/644,536, filed on Jan. 18, 2005.
(60) Provisional application No. 60/644,747, filed on Jan. 18, 2005.
(60) Provisional application No. 60/644,534, filed on Jan. 18, 2005.
(60) Provisional application No. 60/644,720, filed on Jan. 18, 2005.
(60) Provisional application No. 60/644,688, filed on Jan. 18, 2005.
(60) Provisional application No. 60/644,636, filed on Jan. 18, 2005.
(60) Provisional application No. 60/644,517, filed on Jan. 18, 2005.
(60) Provisional application No. 60/644,609, filed on Jan. 18, 2005.
(60) Provisional application No. 60/644,516, filed on Jan. 18, 2005.
(60) Provisional application No. 60/644,546, filed on Jan. 18, 2005.
(60) Provisional application No. 60/644,547, filed on Jan. 18, 2005.
(60) Provisional application No. 60/644,638, filed on Jan. 18, 2005.
(60) Provisional application No. 60/644,537, filed on Jan. 18, 2005.
(60) Provisional application No. 60/644,637, filed on Jan. 18, 2005.
(60) Provisional application No. 60/644,719, filed on Jan. 18, 2005.
(60) Provisional application No. 60/644,784, filed on Jan. 18, 2005.
(60) Provisional application No. 60/644,636, filed on Jan. 18, 2005.

(51) Int. Cl. F21V 17/02

(52) U.S. Cl. 362/282

(57) ABSTRACT

An apparatus, method, and system for high intensity lighting with target area. One aspect includes extending a structure externally of a light fixture and utilizing a very high total reflectance reflecting surface on the structure to redirect incident light toward the target area in a highly efficient manner.

### CROSS REFERENCE TO RELATED APPLICATIONS

This application claims priority under 35 U.S.C. § 119 of a provisional application U.S. Ser. No. 60/644,636 filed Jan. 18, 2005, herein incorporated by reference in its entirety. This application is also a non-provisional of the following provisional U.S. applications, all filed Jan. 18, 2005: U.S. Ser. No. 60/644,639; U.S. Ser. No. 60/644,536; U.S. Ser. No. 60/644,747; U.S. Ser. No. 60/644,534; U.S. Ser. No. 60/644,720; U.S. Ser. No. 60/644,688; U.S. Ser. No. 60/644,517; U.S. Ser. No. 60/644,609; U.S. Ser. No. 60/644,516; U.S. Ser. No. 60/644,546; U.S. Ser. No. 60/644,547; U.S. Ser. No. 60/644,638; U.S. Ser. No. 60/644,537; U.S. Ser. No. 60/644,637; U.S. Ser. No. 60/644,719; U.S. Ser. No. 60/644,784; U.S. Ser. No. 60/644,687, each of which is herein incorporated by reference in its entirety.

### INCORPORATION BY REFERENCE

The contents of the following U.S. patents are incorporated by reference by their entirety: U.S. Pat. Nos. 4,816,974; 4,947,303; 5,161,883; 5,600,537; 5,816,691; 5,856,721; 6,036,338.

### I. BACKGROUND OF THE INVENTION

A. Field of the Invention

The present invention relates to lighting fixtures that produce high intensity, controlled, and concentrated light beams for use at relatively distant targets. In particular, the invention relates to such lighting fixtures, their methods of use, and their use in systems where a plurality of such fixtures are used in combination, usually elevated on poles, to compositely illuminate a target area energy-efficiently, with reduced glare and spill light, and with the capability to lower capital and/or operating costs. One primary example is illumination of a sports field.

B. Problems in the Art

This general configuration of sports lighting fixtures 2 (see FIGS. 1A-F) has remained relatively constant over many years because it is a relatively economical and durable design. It represents a reasonable compromise between the desire to economically control high intensity light to a distant target while at the same time minimizing wind load, which is a particularly significant issue when fixtures are elevated out-of-doors to sometimes well over 100 feet in the air. A much larger reflector could control light better. However, the wind load would be impractical. A significant amount of the cost of sports lighting systems involves how the lights are elevated. The more wind load, the more robust and thus more expensive, the poles must be.

In recent times, sports lighting has also had to deal with the issue of glare and spill light. Therefore, competing interests and issues provide challenges to sports lighting designers. Some of the interests and issues can be at odds with one another. For example, the need always remains for more economical sports lighting. On the other hand, glare and spill control can actually add cost and/or reduce the amount of light available to light the field. Designers have to balance a number of factors, for example, cost, durability, size, weight, wind load, longevity, and maintenance issues, to name a few. Attempts to advance the art have mainly focused on discrete aspects of sports lighting. For example, computerized design of lighting systems tends to minimize hardware costs and system installation costs but uses conventional lamp and fixture technology, with their weaknesses. Also, larger lumen output lamps produce more light, but are used with conventional fixture technology. A need, therefore, still exists for advancement in the art of sports lighting.

Current wide or large area lighting systems suffer from such things as energy lost in conversion of electricity to light energy; energy lost in the lighting fixture; and energy lost in light going to unintended or non-useful locations. The present invention addresses these issues.

### II. SUMMARY OF THE INVENTION

The present invention also provides the ability to select different configurations to meet different needs for a lighting application. For example, features of the lighting system can be selected to achieve lower capital costs for the lighting system. Features can be selected to lower operating costs. Features can be selected to reduce glare and spill light. Features can be selected to increase the quantity or quality of light at and above the target space and/or the performance of the system. The invention allows concentration on just one of the above-listed features or on combinations of them.

In one aspect of the invention, a lighting fixture includes a visor with a very high total reflectance reflecting surface.

In another aspect, the visor comprises an exterior and shape to promote improved effective projected area and aerodynamics.

A. Objects, Features, or Advantages, of the Invention

It is therefore a principal object, feature, or advantage of the present invention to present a high intensity lighting fixture, its method of use, and its incorporation into a lighting system, which improves over or solves certain problems and deficiencies in the art.

Other objects, features, or advantages of the present invention include such a fixture, method, or system which can accomplish one or more of the following:

a) reduce energy use;

b) increase the amount of useable light at each fixture for a fixed amount of energy;

c) more effectively utilize the light produced at each fixture relative to a target area;

d) is robust and durable for most sports lighting or other typical applications for high intensity light fixtures of this type, whether outside or indoors;

e) can reduce glare and spill light relative a target space or area;

f) can reduce wind drag or effective projected area (EPA) of individual fixtures or sets of fixtures, which can allow smaller and/or less expensive elevating structures (e.g. poles), which in turn can materially decrease the capital cost of a lighting system.

B. Exemplary Aspects of the Invention

In an aspect of the invention, an additional reflecting surface extends forwardly from the general surface of revolution of the main reflecting surface and is made of high reflectivity material. As opposed to conventional visors which are used primarily to block light, this reflecting surface can function not only to block light that could be glare or spill light, but efficiently and in a highly controllable manner redirect the otherwise wasted light to the target area. The framework supporting the additional reflecting surface can be connected to the framework for the main reflecting surface in an integrated manner that also minimizes wind drag for the entire fixture.

These and other objects, features, advantages and aspects of the present invention will become more apparent with reference to the accompanying specification and claims.

### III. BRIEF DESCRIPTION OF THE DRAWINGS

FIGS. 1A-F show a typical sports lighting system.

FIGS. 2A-E are views of one exemplary embodiment of an arc tube that could be used with the invention.

FIGS. 3A and B are views of an arc lamp that could be used with the invention.

FIGS. 4A and B is an exploded view of an embodiment of the invention.

FIGS. 5A B are various views of the fixture of FIG. 4 with a first exemplary embodiment of a visor (sometimes referred to as the short visor) according to the present invention.

FIGS. 6A and B are similar to FIGS. 5A and B but with a second exemplary embodiment of a visor (sometimes referred to as the long visor) according to the present invention.

FIG. 7A is a side-by-side perspective view of the two visors of FIGS. 5A and 6A attached to a lens ring that can be mounted to a reflector frame and also showing examples of high reflectivity reflecting strips mounted on the underside of the visors.

FIG. 7B is a partial perspective view showing the left-most visor of FIG. 7A.

FIGS. 8A and B are additional perspective views of the left-most reflector of FIG. 7A.

FIGS. 9A and Bs are additional perspective views of the right-most reflector of FIG. 7A.

FIGS. 10A and 11A-D are views of a visor reflective insert upper rail and lower rail respectively, mountable on the inside of a visor to which can be attached high reflectance reflective insert strips such as shown in FIGS. 7A-9A.

FIGS. 12A-D show a visor transition clip securable to the inside of a visor for a transition between different sets of reflective inserts at different levels.

FIG. 13 is a plan view of a base visor attachable to the lens rim of FIG. 23A.

FIG. 14 is a plan view of a visor extension attachable to the base visor of FIG. 13 to form the short visor of FIGS. 5A and 7A.

FIG. 15 is a plan view of an alternative visor extension connectable to the base visor of FIG. 13 to form the long visor FIGS. 6A and 9A.

FIGS. 16A-B illustrate one example of longer visor inserts.

FIGS. 17A-C are various views of a specially configured end reflective visor insert positionable at opposite lateral sides of a visor.

FIGS. 18A-B are an alternative embodiment of a reflective visor insert.

FIGS. 19A-C is an alternative embodiment of the opposite end reflective visor insert useable with the reflective inserts of FIG. 18A.

FIGS. 20A-C are views of a visor insert support for visor inserts of FIGS. 16A and 17A.

FIGS. 21A-C are views of a visor insert support useable with the reflective inserts of FIGS. 18A and 19A.

FIGS. 22A-C are views of a visor insert assembly alignment bracket.

FIGS. 23A-F illustrates a lens rim used with the embodiment of the preceding figures.

### IV. DETAILED DESCRIPTION OF EXEMPLARY EMBODIMENTS

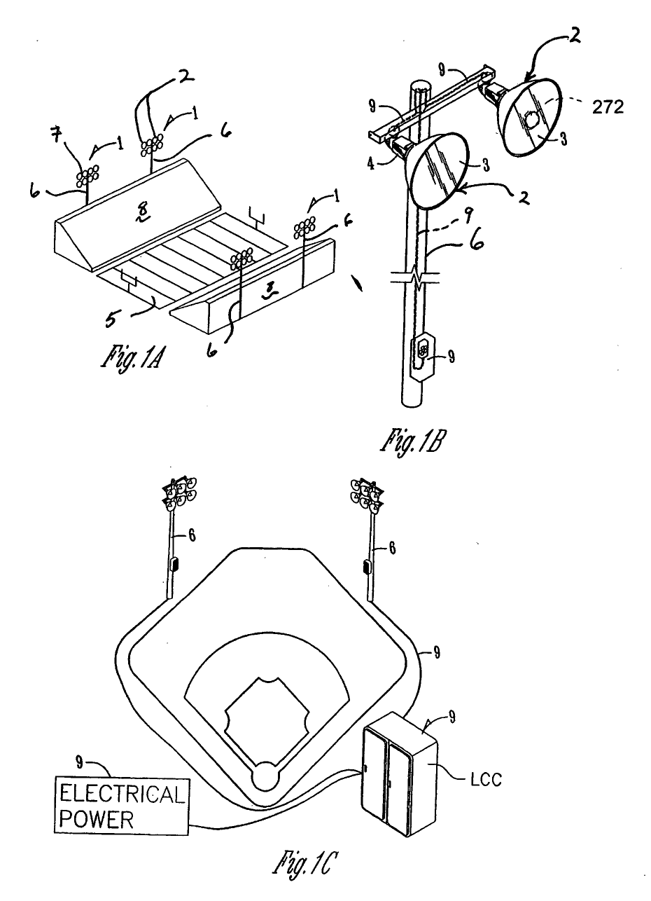

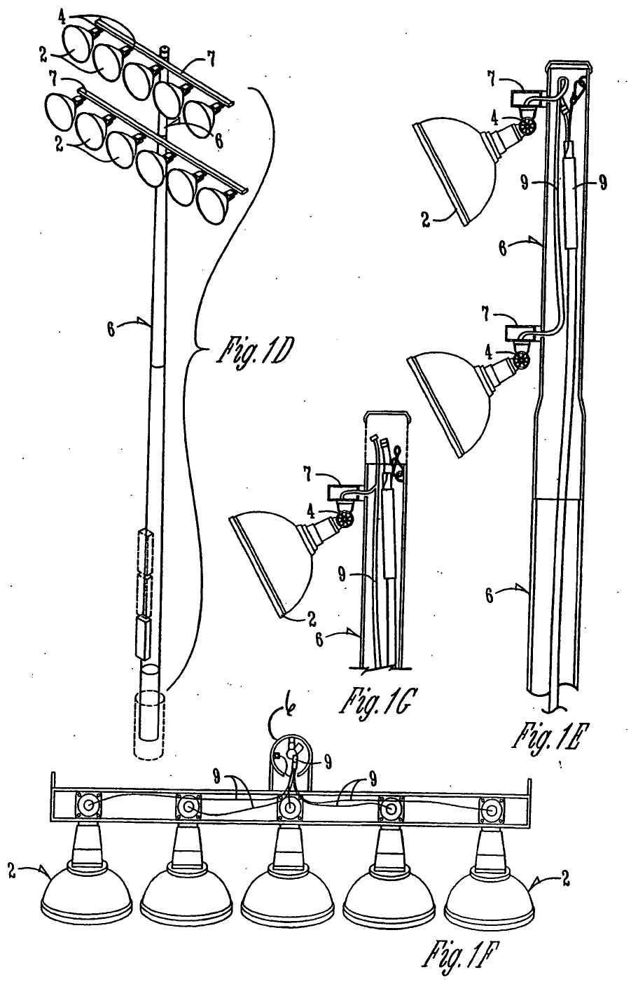

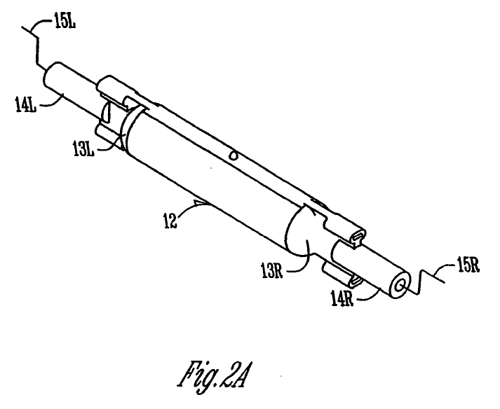

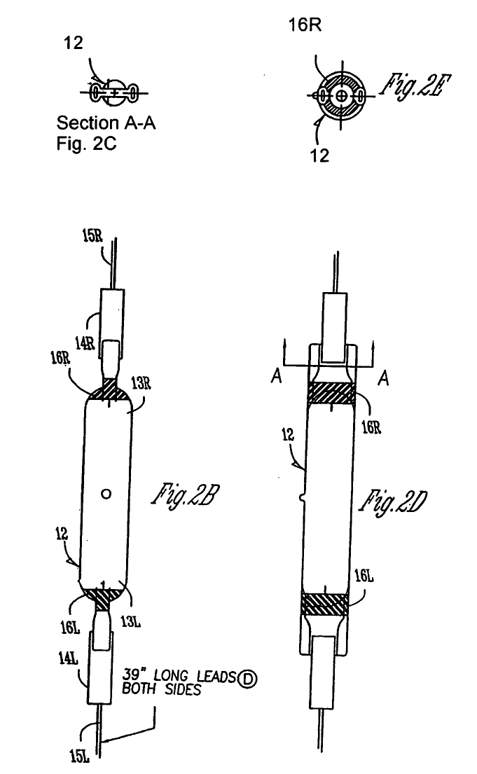

An embodiment of a light fixture will be described in the context of sports lighting, sports lighting fixtures, and sports lighting systems for the illumination of athletic fields such as shown in FIGS. 1A and 1C. In this context, the athletic field is therefore the target area or space.

A. Exemplary Apparatus
1. Lighting Fixture 10 Generally

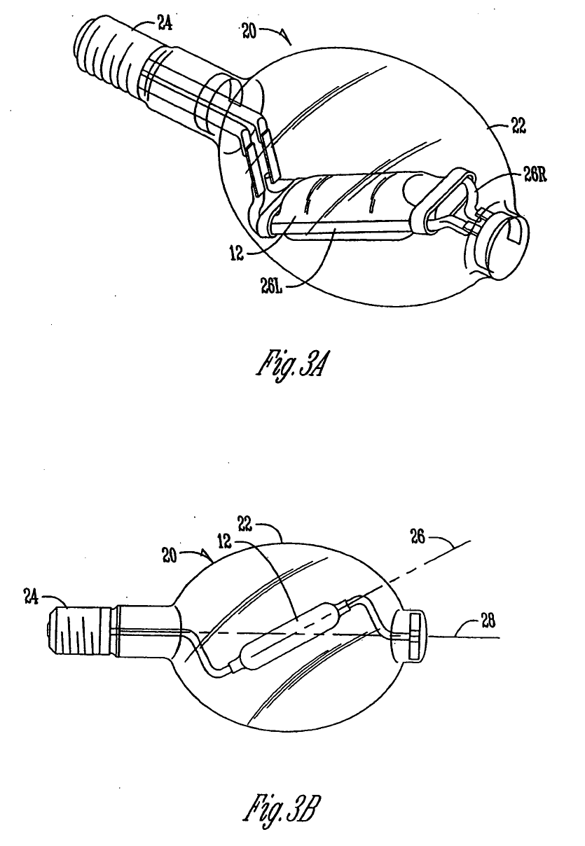

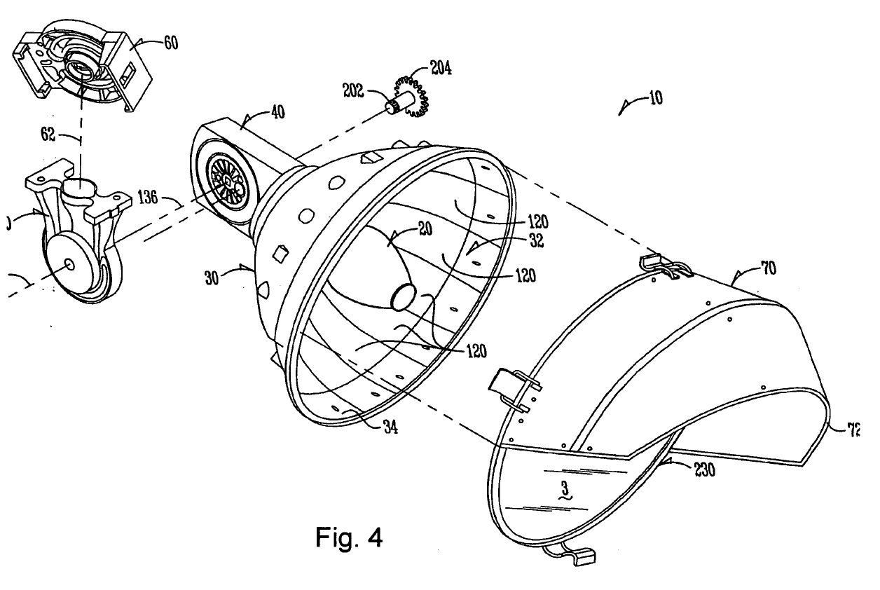

FIG. 4 shows the basic components of sports lighting fixture 10 in exploded form. FIGS. 5A and B show it in assembled perspective form. Fixture 10 has some similar general components to state-of-the-art sports lighting fixtures, but introduces some different structural components and concepts.

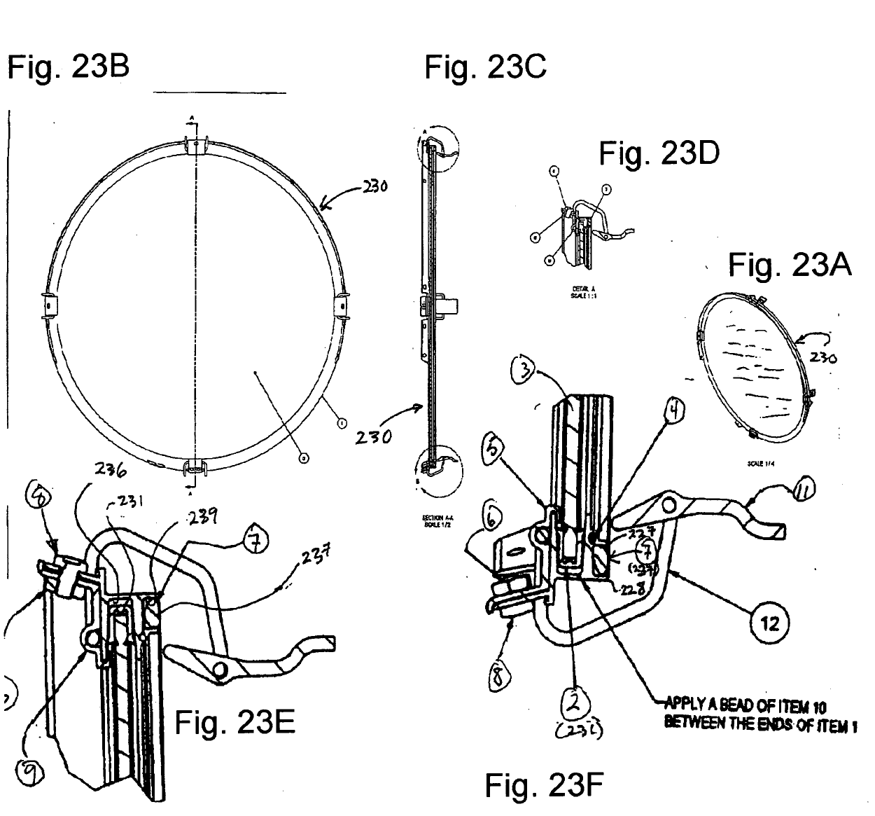

Reflector frame 30 (cast aluminum type 413) bolts to lamp cone 40. The frame (FIG. 23A) for glass lens 32 is removably latched to the front of reflector frame 30. Visor 70 is mountable to the lens frame and extends from the upper front of reflector frame 30 when in place. It includes high reflectivity strips on its interior 72.

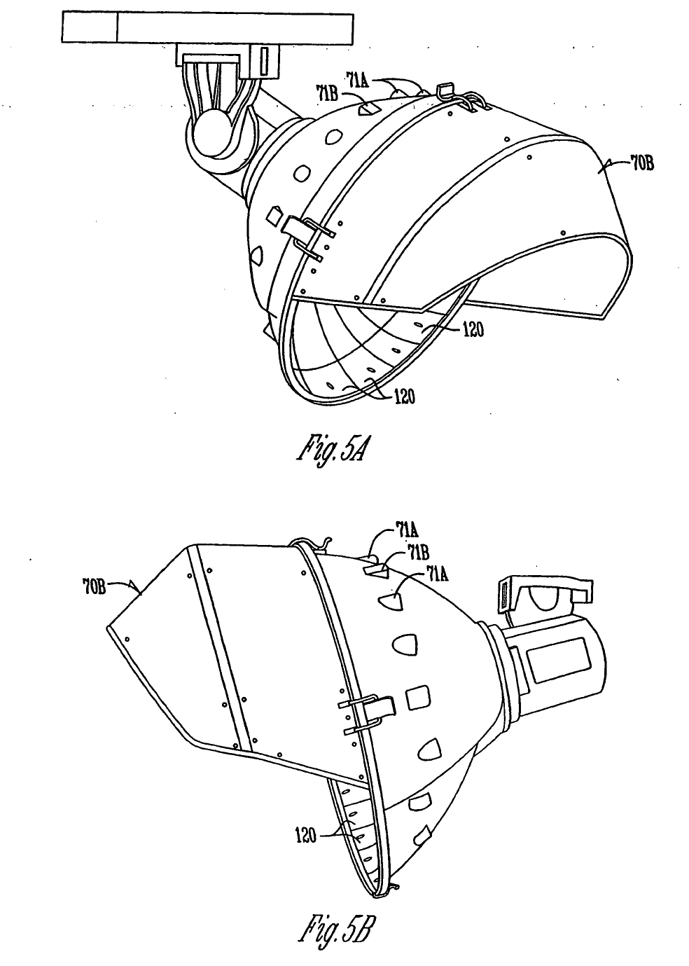

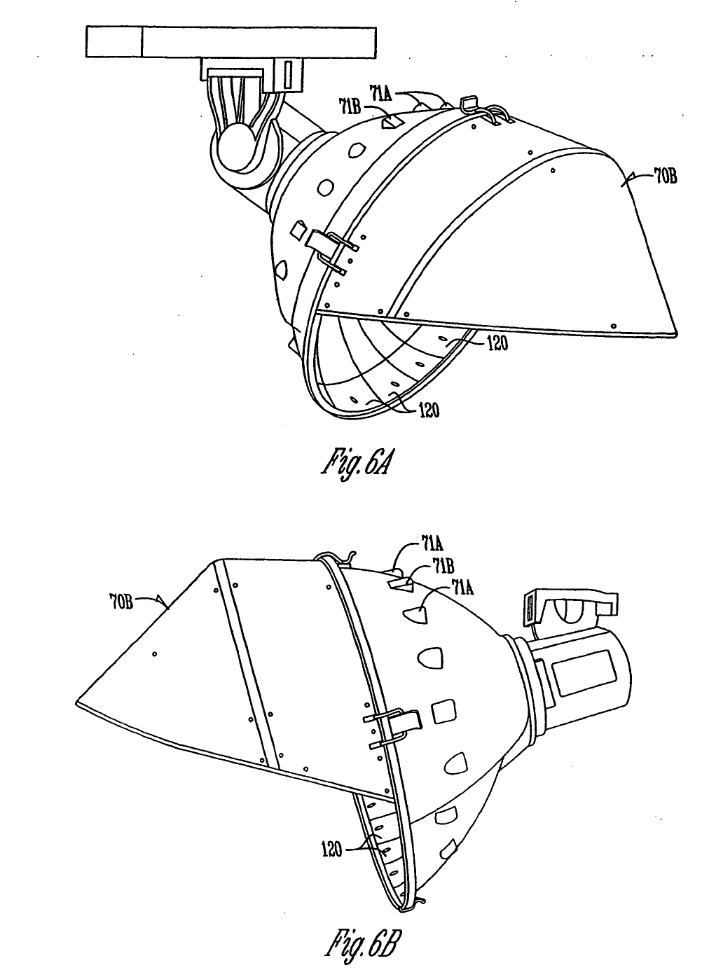

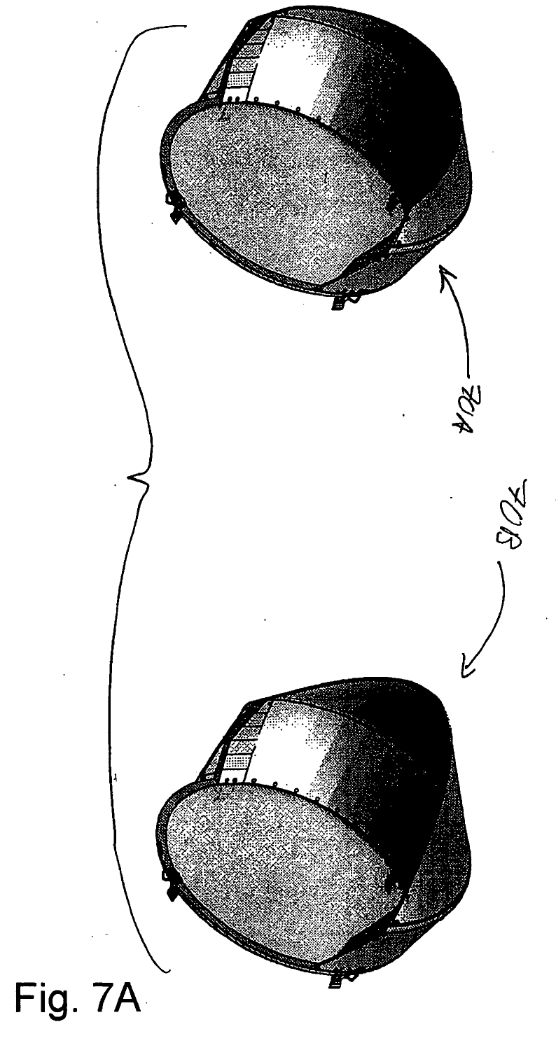

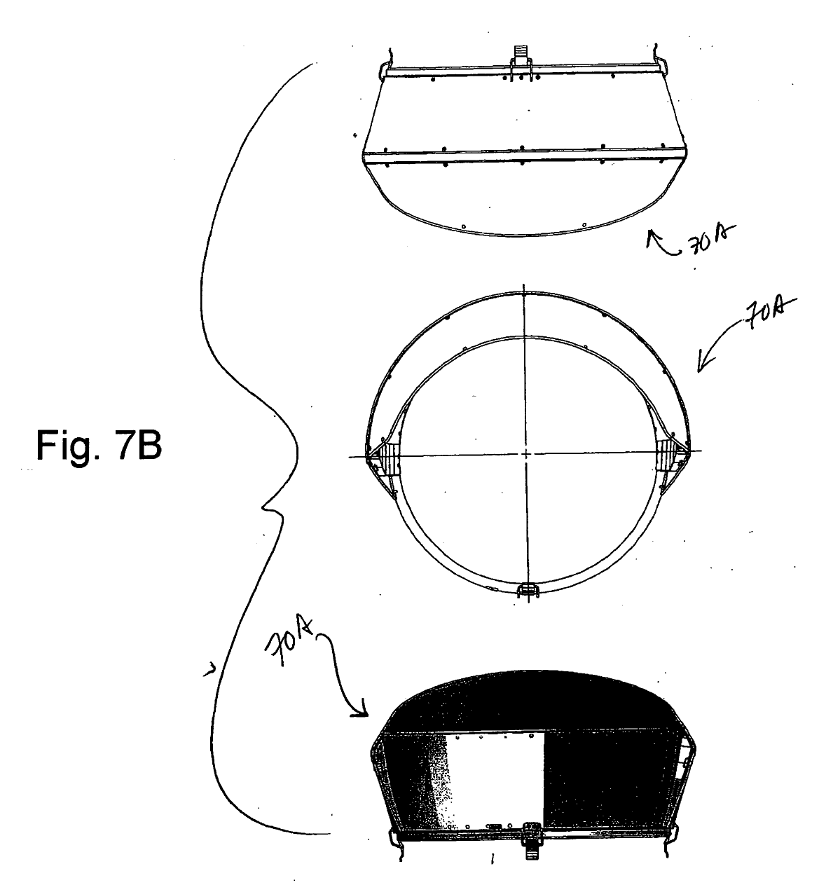

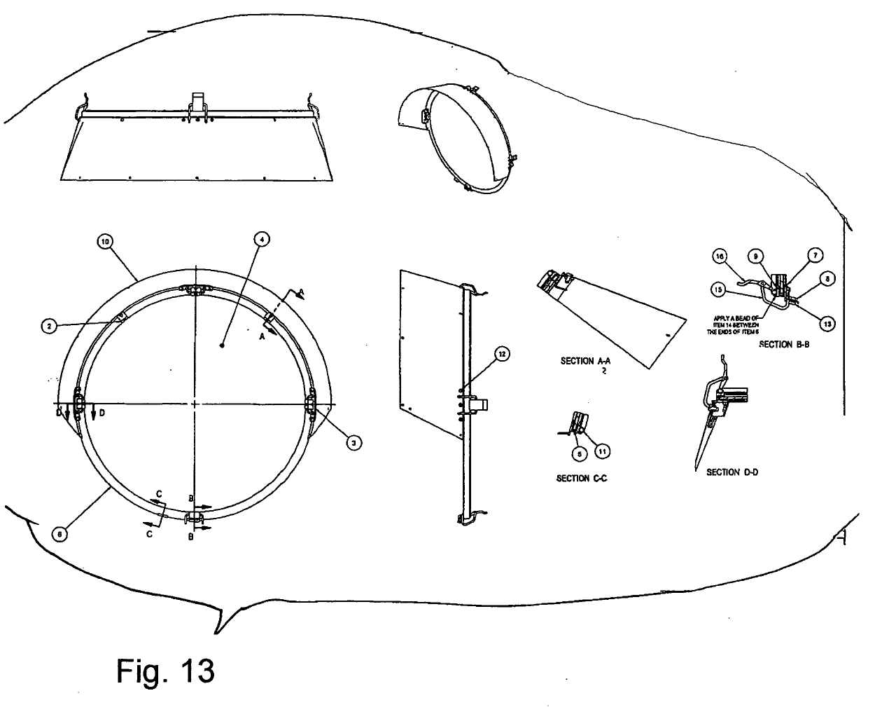

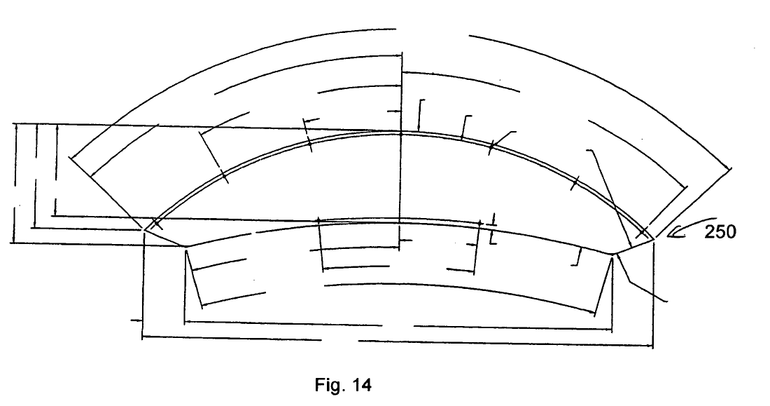

As indicated by comparing FIG. 5A with FIG. 6A, visor 70 can take different shapes and forms. A first style of visor 70A (FIG. 5A) is shorter and does not extend forwardly and downwardly as much as second visor style 70B (FIG. 6A). Both have an identical base section (FIG. 13) that extends initially at a less converging angle from reflector frame 30. A distal extension section connects to the base section and angles back inwardly toward the central axis of reflector frame 30. The shorter visor 70A uses a shorter extension section (FIG. 14) than the longer visor 70B (see extension of FIG. 15). Visor 70B is useful, for example, when fixture 10 is aimed at angles closer to horizontal. It would block and redirect more light that would otherwise go off the target area, as compared to visor 70A.
2. Visor 70

As indicated at FIG. 4, a visor 70 is attachable to fixture 10. High total reflectivity material is mounted on its inner or downward-facing side 22. Essentially the exterior of visor 70 is a protective cover over the high reflectivity material it supports. FIGS. 5A and 6A illustrate two general forms visor 70 can take.

Either form of visor 70 actually is larger in size than many existing visors, and increases the overall size of fixture 10. However, their shape and configuration has been designed to actually decrease wind load by on the order of 40% over conventional fixtures. The length, shape, and edges of visors 70 are designed to improve the EPA of the whole fixture 10. They are cost effective with excellent reflection efficiency.

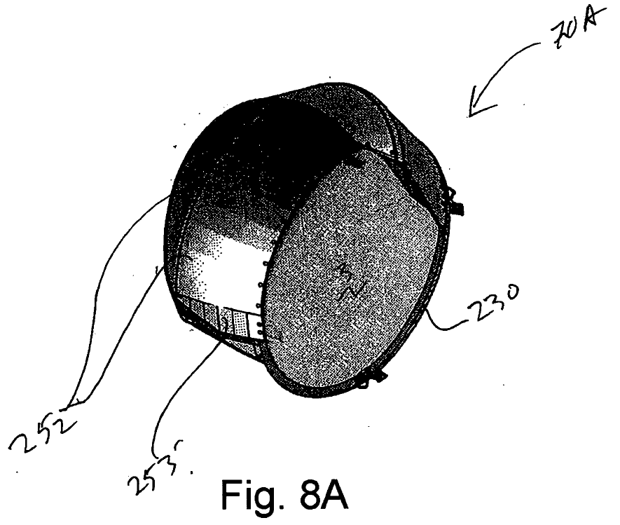

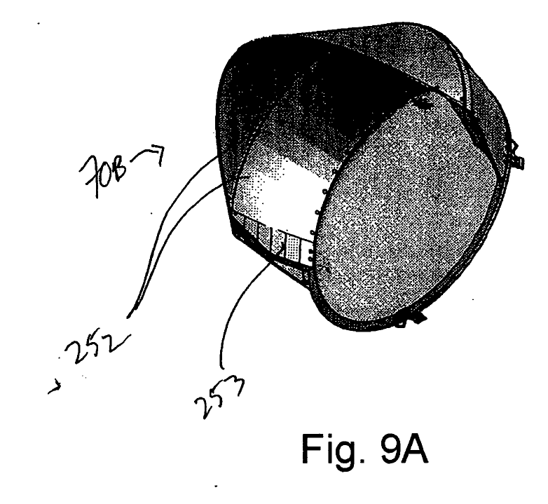

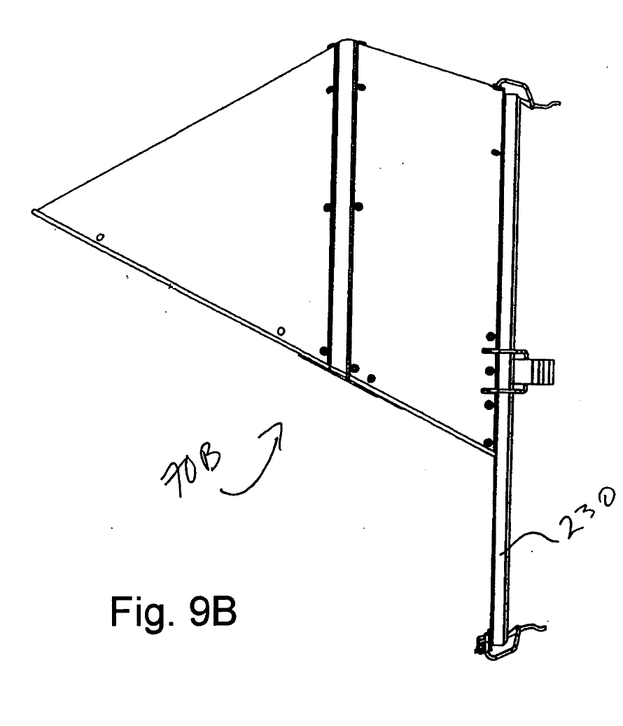

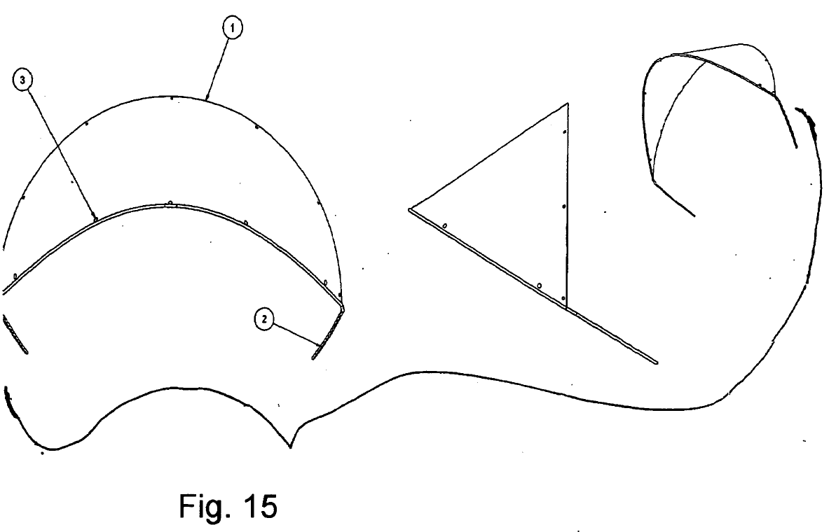

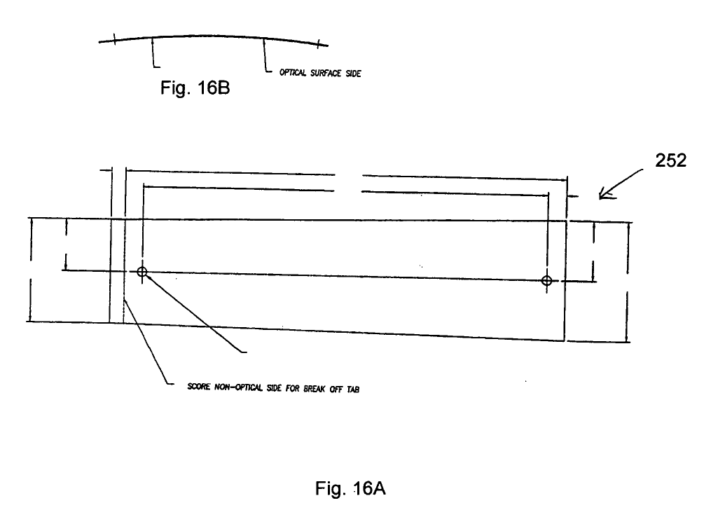

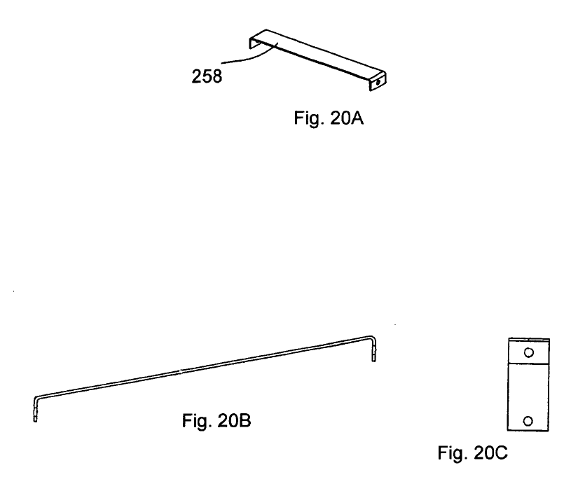

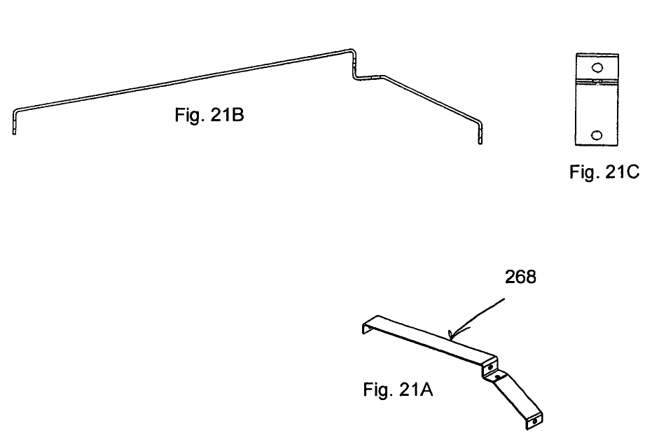

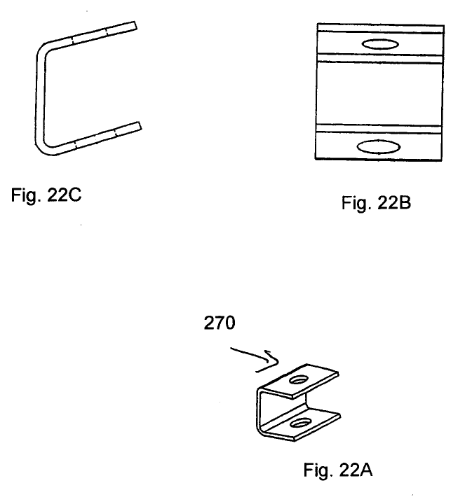

As can be seen in FIG. 8A, a plurality of side-by-side, high reflectivity or reflectance reflector inserts (e.g., reflective inserts 252 of FIG. 16A) are riveted or otherwise secured to the inside of base reflector 240 and attached reflector 250. Alternatively, upper and lower rails 254 and 256 can be attached to proximal and distal positions on the inside of visor combination 240/250, and the reflective visors installed into slots 255 and 257 respectively, and then riveted or bolted into place (see openings in rails 254 and 256). One or more radial support brackets 258 (see FIG. 20A), can be connected back to front of visor combination 240 and 250 to provide more rigidity for upper and lower visor reflective insert rails 254 and 256. Examples of high reflectivity inserts and materials are discussed in U.S. Pat. No. 6,036,338.

The shape of visor 70 is designed to achieve several functions. First, it supports the highly reflective inserts in a manner that controls spill and glare light. Second, it supports the reflective inserts in a manner which minimizes light loss, and can increase light to the target. Third, its shape minimizes the projected area of the visor and the fixture generally to produce a low coefficient of drag. Fourth, it accomplishes these functions in a relatively low cost but efficient way.

Even though the overall size of fixture 10 is larger than some conventional similar fixtures, the wind drag is reduced on the order of 40% or more. Spill and glare can be controlled with a visor 70, but also with other features disclosed herein, if used (e.g. lower initial output intensity, side shift, reflecting surfaces that highly control direction of light). This can allow cheaper poles to be utilized, which can significantly reduce overall capital cost of a lighting system. Less wind drag means the strength of the pole that elevates the fixtures can be less.

Visor 70 can be used even if glare and spill control is not an issue because of improved EPA of the fixture, which can reduce cost of poles. It has excellent efficiency and is relatively low cost. This is especially beneficial for outdoors sports lighting.
3. Visor Options

Optionally a prismatic material could be used in the visor opening for different lighting effects. An angled stepped prismatic reflector inside reflector 70 could also be used. Black paint could be used on the opposite sides of the visor reflecting surface for extreme glare and spill light control.

The visor, or the whole reflector frame/visor combination could be painted, ornamented, or otherwise configured in the colors of a team or school. Because the reflector frame and visor exteriors are cast, and do not contain the reflecting surface, painting is a more viable option.

It will be appreciated that the invention can take many forms and embodiments. Variations obvious to those skilled in the art will be included within the invention. The scope of the invention is defined solely by the claims and not by the specific examples herein.

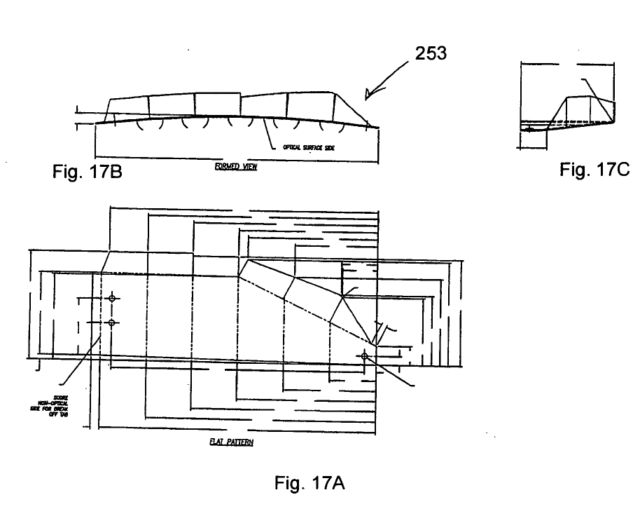

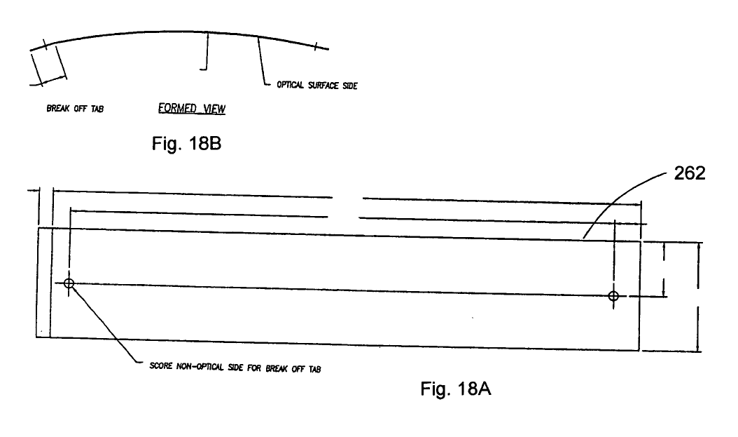

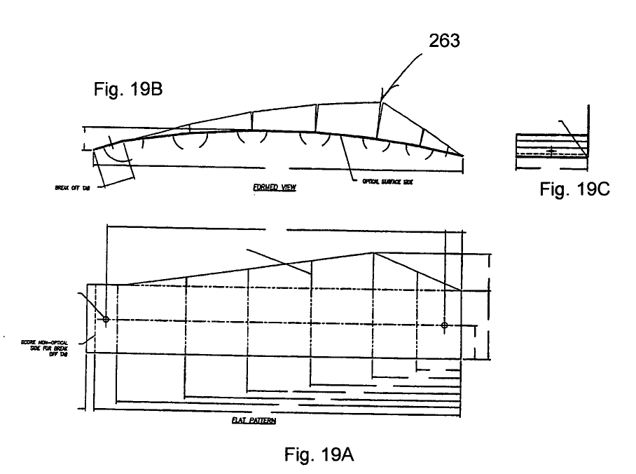

For example, the method of attaching the reflective strips or other high reflectance surface to the underside of visor 70 can vary, as can the way it is supported. FIGS. 17-A-C and 19A-C illustrate reflective inserts that can be mounted at opposite sides of reflector 70. They have a shape to match the sides of visor 70.

Use of inserts allows for a relatively easy way to add a precise, high reflectivity surface. Change in shape of inserts can alter the way light is controlled so the designer can select them according to need or desire.

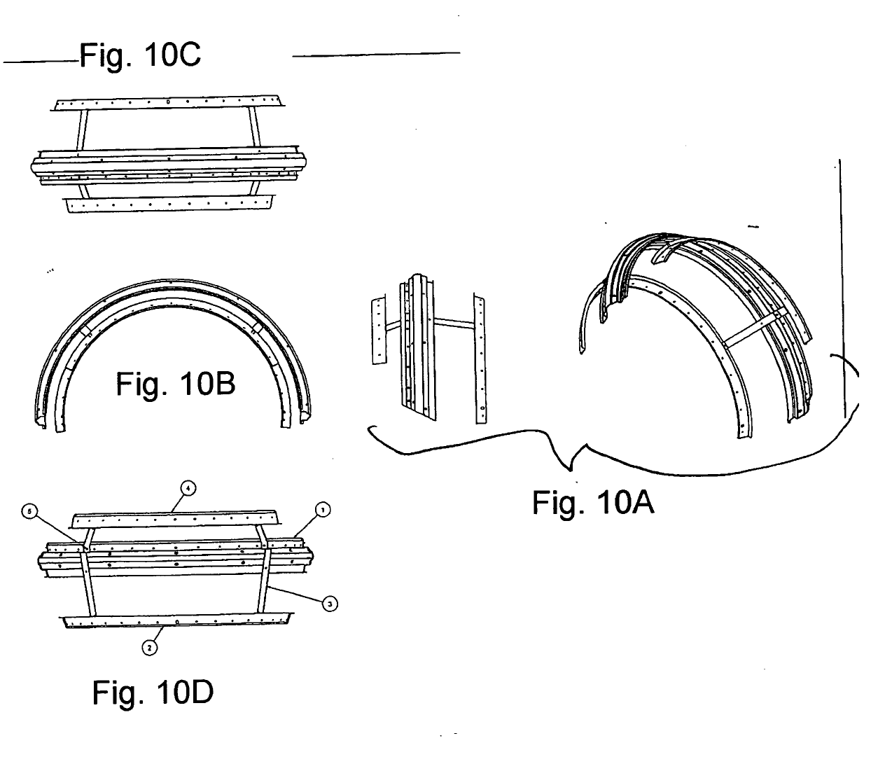

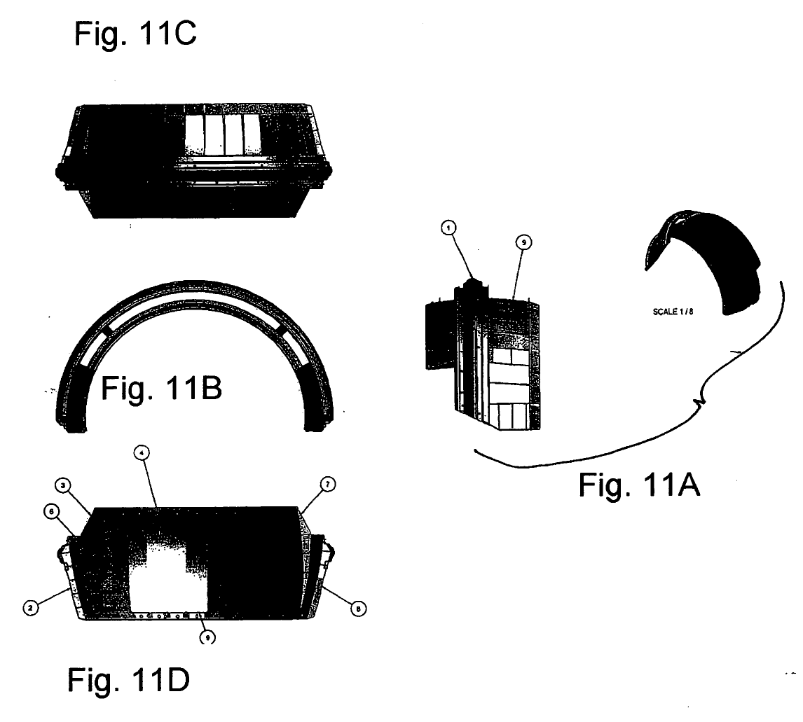

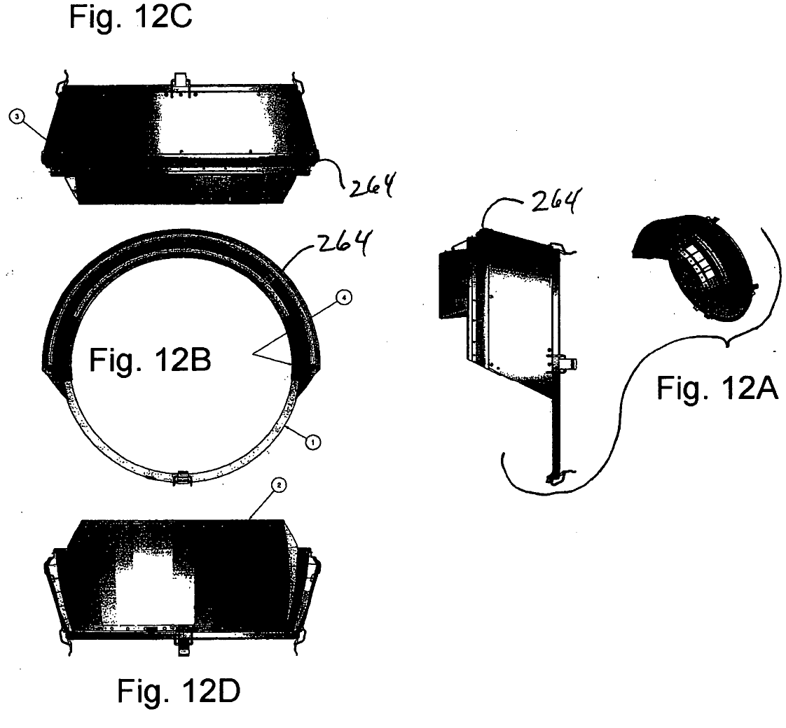

The figures illustrate one way of building a visor 70. A sheet aluminum base reflector is attached to a lens rim (FIG. 13). A framework of aluminum or metal pieces is built (FIGS. 10A-D). Reflective insert strips and pieces are mounted to that framework (FIGS. 11A-D). The framework with attached reflective inserts is attached to the base reflector (FIGS. 12A-D). A visor extension, either a short aluminum sheet piece or long piece (FIG. 15) is then attached to the sub-assembly of FIGS. 12A-D.

What is claimed is:

1. An high intensity lighting fixture for increasing useable light to a target area without an increase in energy use comprising:
a. a reflector frame mountable to the lamp cone and comprising a bowl-shaped outer surface, an inner surface including mounting structure adapted for a reflecting surface, and a primary opening over which a glass lens is mountable;
b. a visor mounted to and extending outwardly from the top of the reflector frame having an outer side and an inner side;
c. a very high total reflectance reflecting surface mountable to the inner side of the visor adapted to redirect incidence light generally downward when the fixture is in operating position relative a target area.

2. The lighting fixture of claim 1 wherein the visor inner side is adapted to support a high total reflectance reflecting surface extending outward from the reflector frame.

3. The lighting fixture of claim 1 wherein the visor reflecting surface extends forwardly of and above the lamp when the fixture is in operating position.

4. The lighting fixture of claim 1 wherein the visor reflecting surface extends about or greater than 180° around the longitudinal axis of the lamp.

5. The lighting fixture of claim 1 wherein the visor reflecting surface is of a different shape than the main portion of the reflecting surface.

6. The lighting fixture of claim 1 wherein the visor reflecting surface redirects light generally downward to the target area when the fixture is in operating position.

7. The lighting fixture of claim 1 wherein the visor comprises an exterior which, in combination with the reflector frame, presents a relatively improved effective projected area (EPA) and aerodynamic characteristics compared to conventional spun aluminum reflector fixtures.

8. A method of high intensity lighting to a target area for increase usable light without an increase in energy use, the lighting being supplied by one or more fixtures issuing light from a light output side, comprising:
a. extending a structure externally of the fixture at or near the light output side of the fixture;
b. utilizing very high total reflectance reflecting surface on the extension;
c. so that incident light on the very high total reflectance reflecting surface can be redirected to the target to place more usable light at the target.

9. The method of claim 8 further comprising selecting between types, size, and reflecting characteristics of the very high total reflectance reflecting surface.

10. The method of claim 8 wherein the extending structure is configured to minimize wind drag and/or have a reduced effective projected area.
